(19) United States
(12) Patent Application Publication
(10) Pub. No.: US 2006/0175869 A1
(43) Pub. Date: Aug. 10, 2006

(54) Sun visors for vehicles

(75) Inventors: Hidekazu Torii, Toyota-shi (JP); Satoshi Takimoto, Toyota-shi (JP)

Correspondence Address: CONLEY ROSE, P.C., P. O. BOX 3267, HOUSTON, TX, 77253-3267, US

(73) Assignees: Kyowa Sangyo Co., LTD., Toyota-shi (JP); Shinwa Seiko Co., LTD., Toyota-shi (JP)

(21) Appl. No.: 11/348,200

(22) Filed: Feb. 6, 2006

(30) Foreign Application Priority Data
Feb. 10, 2005 (JP) 2005-34436

(51) Int. Cl. B60J 3/00

(52) U.S. Cl. 296/187.05

(57) ABSTRACT

A sun visor for a vehicle has a visor body and a pivot shaft. The visor body shields a vehicle cabin from light that would otherwise enter. The pivot shaft is inserted into the visor body and rotatably supports the visor body about the axis. The visor body has a joint member therein for joining the visor body with the pivot shaft. The joint member is extended or contracted when the visor body receives an impact force in a direction corresponding to the visor body slipping-off of the pivot shaft. Therefore the joint member inhibits the visor body from slipping-off of the pivot shaft in an axial direction by elastic or cushioning action, adsorbing at least a portion of the impact force. The joint member can be a resilient member or a dampener for example.

This application claims priority to Japanese patent application serial number 2005-34436, the contents of which are incorporated herein by reference.

### BACKGROUND OF THE INVENTION

1. Field of the Invention

The present invention relates to a sun visor for a vehicle including a visor body and a pivot shaft. The visor body provides a shield inhibiting a section of light from coming into the cabin of the vehicle. The pivot shaft is inserted into the visor body and rotatably supports the visor body on an axis. More particularly, the invention relates to a sun visor for a vehicle having a slipping-off preventing structure for preventing the visor body from slipping-off of the pivot shaft in an axial direction when the airbags deploy and impact the visor body.

2. Description of the Related Art

In the prior art a variety of sun visors for a vehicle are known, including one described in Patent Publication 1 (JP-A-2003-127662) for example.

The sun visor for a vehicle described in Patent Publication 1 includes a clip in the visor body for biasing the visor body toward a cabin ceiling. A pivot shaft is inserted into the clip. This clip has engagement pawls that protrude toward a groove formed on the pivot shaft so that the engagement pawls slidably engage with the groove. Thereby, the engagement pawls and the groove prevent the visor body from slipping-off of the pivot shaft.

However, most of vehicles in recent years are equipped with airbags in the cabin ceiling. When the airbags deploy the visor body receives an impact from the airbags in a direction corresponding to the visor body slipping-off of the pivot shaft in the axial direction (as referred to in FIG. 1). Therefore, in recent years a structure is earnestly desired that can reliably prevent the visor body from slipping-off of the pivot shaft in the axial direction when the airbags deploy and the visor body receives an impact from the airbags.

As a result, this invention has as an object to provide a sun visor for a vehicle capable of preventing the visor body from slipping-off of the pivot shaft in the axial direction when the airbags deploy, causing the visor body to receive an impact from the airbags.

### SUMMARY OF THE INVENTION

It is accordingly an object of the present invention to teach a sun visor for a vehicle that has a visor body and a pivot shaft inserted into the visor body. In addition, the visor body may include a joint member joining the visor body and the pivot shaft.

In one aspect of the present teachings, the joint member is expanded or contracted when the visor body is subjected to an impact force in the direction of the visor body slipping-off of the pivot shaft. Thereby the joint member inhibits the visor body from slipping-off of the pivot shaft in the axial direction via elastic or cushioning action.

Consequently, when the visor body is subjected to a force, the force can at least be partially absorbed by the joint member. As a result, the joint member can effectively inhibit the visor body from slipping-off of the pivot shaft. Moreover, the joint member may assist in preventing the visor body and the pivot shaft from being broken by the impact.

In another aspect of the present teachings, the joint member is made of an elastic member. The joint member has one end portion attached to the pivot shaft and extending in the axial direction of the pivot shaft. The other end portion of the joint member has an extending tip end attached to the visor body. One end portion or the other end portion of the joint member is attached to the pivot shaft or the visor body so as to rotate about the axis of the pivot shaft.

The elastic joint member elastically extends or contracts when the visor body is subjected to an impact in an axial direction. Therefore, the elastic joint member can prevent the visor body from slipping-off of the pivot shaft in the axial direction. On the other hand, when the visor body is rotated about the pivot shaft axis relative to the pivot shaft the elastic joint member is rotated at one end portion or the other end portion about the pivot shaft axis with respect to the pivot shaft or the visor body. As a result, torsion build-up of the elastic joint member is eliminated to facilitate the rotating action of the visor body about the axis relative to the pivot shaft.

In another aspect of the present teachings, the joint member is made of a damper comprising two members, a cylinder and a piston rod inserted on one end side into the cylinder. The damper is configured such that one of the two members is attached to the pivot shaft and extends in the axial direction of the pivot shaft. The other of the two members is attached at an extending tip end to the visor body. The one member or the other member is rotatably attached to the pivot shaft or the visor body so as to rotate about the axis of the pivot shaft. Alternatively, the two members may be joined to rotate about the pivot shaft axis relative to each other.

The damper therefore extends or contracts in a cushioning manner when the visor body is subjected to an impact in an axial direction. Therefore, the damper prevents the visor body from slipping-off of the pivot shaft in the axial direction via the cushioning action. In the damper, moreover, when the visor body is rotated about the axis of the pivot shaft relative to the pivot shaft, the cylinder and the piston rod are rotated about the axis of the pivot shaft relative to the pivot shaft or the visor body. Alternatively, the cylinder and the piston rod may be rotated about the axis of the pivot shaft relative to each other. As a result, the torsion resistance of the damper can be eliminated to rotate the visor body about the axis of the pivot shaft relative to the pivot shaft.

### BRIEF DESCRIPTION OF THE DRAWINGS

FIG. 1 is a perspective view of a sun visor for a vehicle of a first representative embodiment as mounted to a cabin-ceiling surface; and

FIG. 2 is a perspective view of the sun visor of a first representative embodiment; and

FIG. 3 is a perspective view of the sun visor of a first representative embodiment as a visor body of the sun visor receives an impact in a removal direction; and

FIG. 4 is a perspective view of a sun visor of a second representative embodiment; and

FIG. 5 is a perspective view of the sun visor of a second representative embodiment as a visor body of the sun visor receives an impact in a removal direction; and

FIG. 6 is a perspective view of a sun visor of a third representative embodiment; and

FIG. 7 is a perspective view of a sun visor of a fourth representative embodiment.

### DETAILED DESCRIPTION OF THE INVENTION

Each of the additional features and teachings disclosed above and below may be utilized separately or in conjunction with other features and teachings to provide improved sun visors for a vehicle. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### First Representative Embodiment

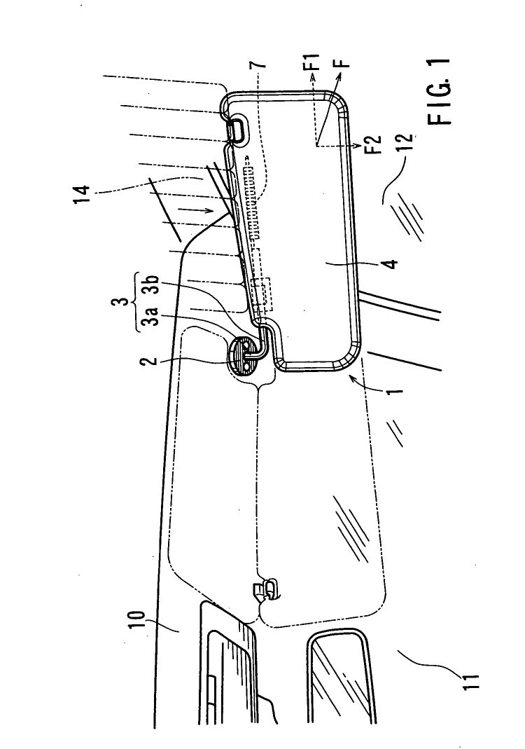

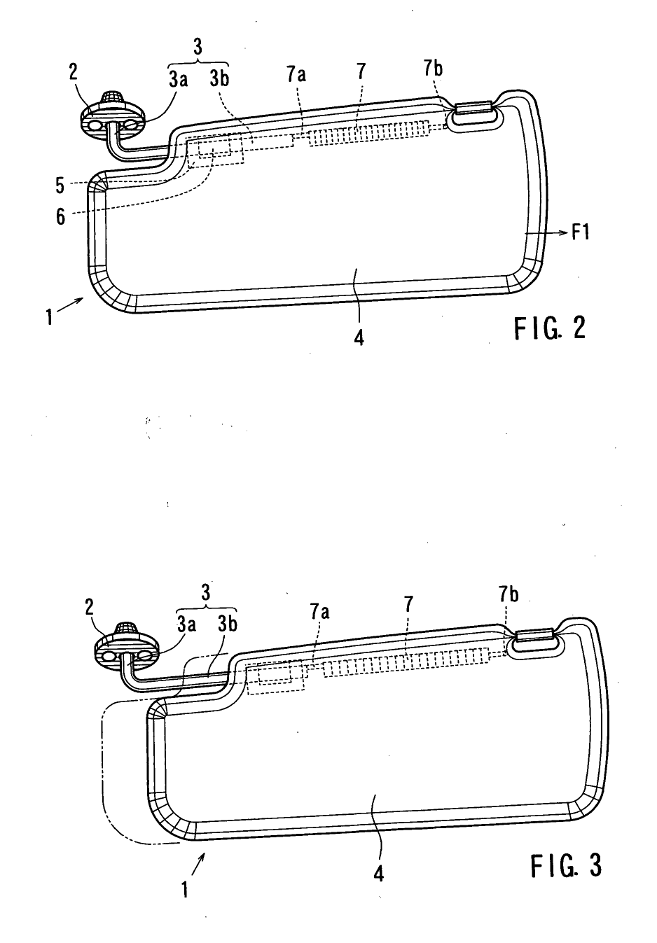

A first representative embodiment of the present invention will now be described with reference to FIGS. 1 to 3. Referring to FIG. 1, a sun visor for a vehicle 1 is equipped with a plate-shaped visor body 4, a pivot shaft 3 inserted into the visor body 4 for supporting the visor body 4 pivotally on an axis, and a bracket 2 for attaching the pivot shaft 3 to the cabin ceiling 10. The visor body 4 is equipped with a joint member 7 for preventing the visor body 4 from slipping-off of the pivot shaft 3, as shown in FIG. 2.

As shown in FIG. 1, the pivot shaft 3 is generally formed into an L-shape and is composed of a vertical shaft portion 3a and a horizontal shaft portion 3b. The horizontal shaft portion 3b is inserted into a bearing member 5 disposed at the upper end edge of the visor body 4. The horizontal portion 3b pivotally supports the visor body 4. The vertical shaft portion 3a is pivotally attached to the cabin ceiling 10 through the bracket 2, and is able to rotate about the axis of the vertical shaft portion 3a.

As a result, the visor body 4 is rotated about the horizontal shaft portion 3b, as shown in FIG. 1, between a light shielding position along a windshield 11 and a storage position along the cabin ceiling 10. Moreover, the visor body 4 is rotated around the vertical shaft portion 3a together with the pivot shaft 3 between a light shielding position along the windshield 11 and a side position along a door glass 12.

The visor body 4 is formed into a hollow or solid plate shape and equipped therein with a bearing member 5 and a clip 6 (see FIG. 2). The bearing member 5 is disposed close to the upper end and to the right or left side of the visor body 4. The horizontal shaft portion 3b of the pivot shaft 3 is inserted into the bearing member 5. The clip 6 may be made of a leaf spring. The clip 6 is attached to the bearing member 5 and contacts the horizontal shaft portion 3b via an elastic force. Therefore, the clip 6 biases the visor body 4 toward the storage position along the cabin ceiling 10 by using the elastic force of the spring.

The joint member 7 is an elastically extending resilient member such as a coil spring. The joint member 7 is attached at one end portion 7a to the tip end of the horizontal shaft portion 3b of the pivot shaft 3 and extends in an axial direction of the horizontal shaft portion 3b. The other end portion 7b or the extended tip end 7b is attached to the visor body 4. Here, it is preferred that at least one of the one end portion 7a or the other end portion 7b is so attached to the pivot shaft 3 or the visor body 4 as to rotate about the horizontal axis of the pivot shaft 3.

As shown in FIG. 1, the cabin ceiling 10 is equipped with curtain-shielded type airbags 14. The airbags 14 of this kind are usually constructed such that they are gradually deployed from the front to the rear sides. On the other hand, when the visor body 4 is located at a side position, the visor body 4 is supported at a front side portion by the pivot shaft 3 in a cantilever manner. As a result, the visor body 4 receives an impact (or force) in the direction of arrow F when the airbags 14 are deployed. This impact F in the arrow direction F is composed of a horizontal impact component F1 and a vertical impact component F2.

As a result, the visor body 4 may receive the impact F1 (or force) in the direction corresponding to the visor body 4 slipping-off of the pivot shaft 3. At this time in the sun visor for a vehicle 1, as shown in FIG. 2, the joint member 7 elastically extends along an axial direction of the pivot shaft 3. Therefore, the visor body 4 can be elastically prevented by the elastic force of the joint member 7 from axially slipping-off of the pivot shaft 3.

The sun visor for a vehicle 1 is constructed, as described herein. Specifically, the joint member 7, for joining the visor body 4 and the pivot shaft 3, is disposed within the visor body 4, as shown in FIG. 2. The joint member 7 elastically extends in the impacted direction when the visor body 4 receives an impact F1 in the direction of the visor body 4 slipping-off of the pivot shaft 3. Thereby elastically preventing the visor body 4 from slipping-off of the pivot shaft 3.

When the visor body 4 receives an impact, this impact can be absorbed by the joint member 7. Therefore, the joint member 7 can effectively prevent the visor body 4 from slipping-off of the pivot shaft 3. Moreover, the joint member 7 may also prevent the visor body 4 and the pivot shaft 3 from being broken by the impact.

Moreover, the joint member 7 is an elastic member that is attached at one end portion 7a to the pivot shaft 3, and at the other end portion 7b to the visor body 4. One end portion 7a or the other end portion 7b is attached to the pivot shaft 3 or the visor body 4 so as to rotate about the axis of the horizontal shaft portion 3b.

As a result, the joint member 7 (or the elastic member) elastically extends or contracts when the visor body 4 receives an impact in an axial direction. When the visor body 4 is rotated about the axis of the horizontal shaft portion 3b relative to the pivot shaft 3, one end portion 7a or the other end portion 7b of the joint member 7 rotates about the axis relative to the pivot shaft 3 or the visor body 4. As a result, any torsion build-up of the joint member 7 (or the elastic member) is eliminated to facilitate the rotating action of the visor body 4 about the axis of the horizontal shaft portion 3b.

### Second Representative Embodiment

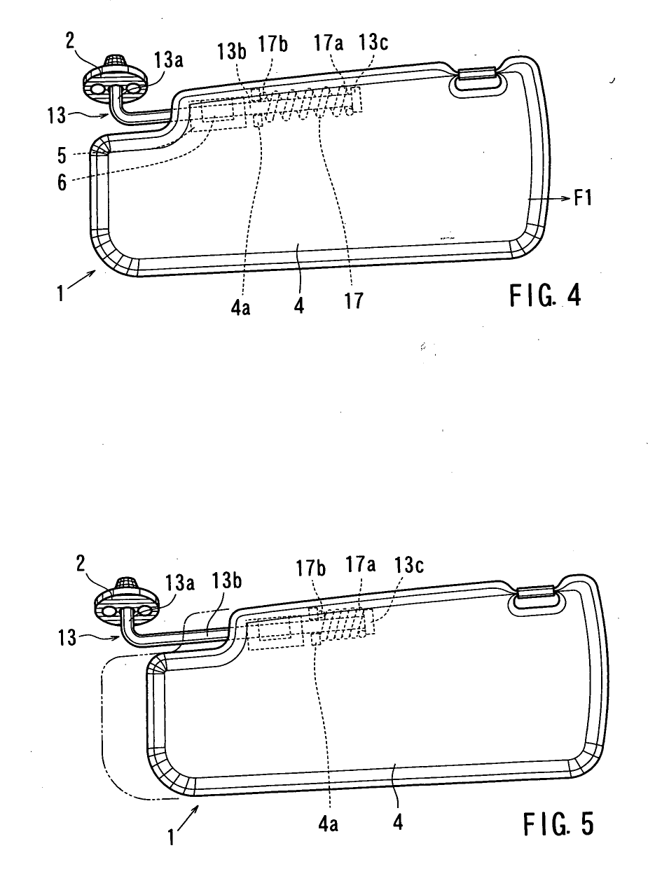

The second representative embodiment will now be described with reference to FIGS. 4 and 5. The second representative embodiment is constructed substantially like the first representative embodiment. However, a joint member 17 according to the second representative embodiment differs from the first representative embodiment in that the joint member 17 is not an elastically extending elastic member, but is instead an elastically contracting elastic member. Therefore, the second representative embodiment will be described primarily with regard to the different constructions.

The joint member 17 is exemplified by a compression spring, as shown in FIGS. 4 and 5. This joint member 17 has an end portion 17a. The end portion 17a is slidably attached or brought into abutment against a flange 13c formed at a tip end of a horizontal shaft portion 13b of a pivot shaft 13. The joint member 17 extends in the axial direction from one end portion 17a to the base end portion of the horizontal shaft portion 13b, while coiling around the outer circumference of the horizontal shaft portion 13b. Consequently, the extending tip end or the other end portion 17b is slidably attached or brought into abutment against a contacting portion 4a formed in the visor body 4.

As a result, the joint member 17 contracts in the direction of the horizontal shaft portion 13b of the pivot shaft 13 when the visor body 4 receives an impact F1 in a direction relative to the pivot shaft 13. Thus, the joint member 17 can elastically prevent the visor body 4 from slipping-off of the pivot shaft 13.

When the visor body 4 rotates about the axis of the horizontal shaft portion 13b, one end portion 17a or the other end portion 17b of the joint member 17 rotates about the axis of the horizontal shaft portion 13b relative to the pivot shaft 13 or the visor body 4. As a result, a build-up of torsion by the joint member 17 (or the elastic member) is eliminated in order to facilitate the rotating action of the visor body 4 about the axis of the horizontal shaft portion 13b relative to the pivot shaft 13.

### Third Representative Embodiment

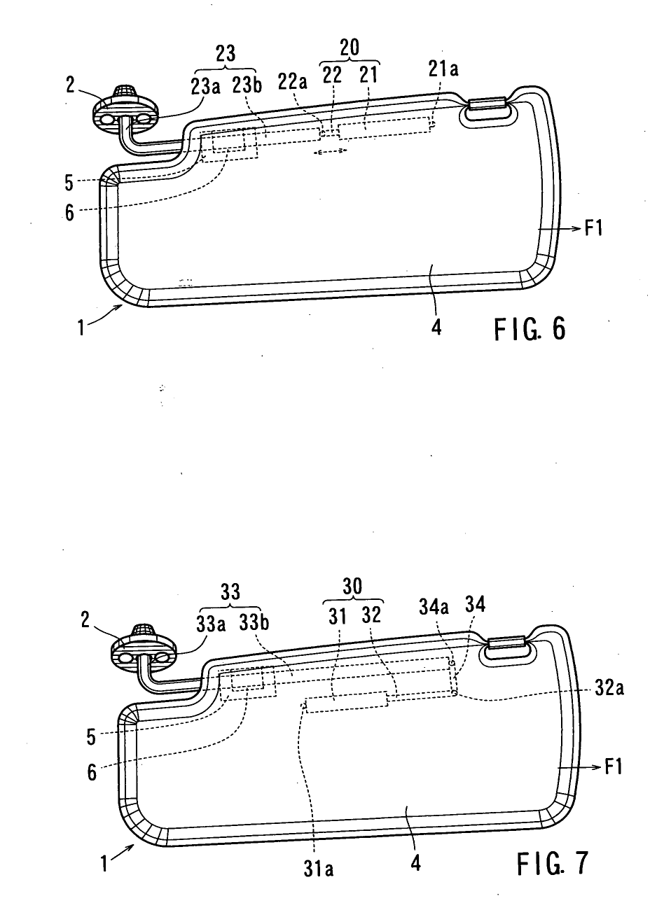

The third representative embodiment will now be described with reference to FIG. 6. The third representative embodiment is constructed substantially like the first representative embodiment. However, the joint member 20, according to the third representative embodiment, differs from the joint member 7 of the first representative embodiment by using a cushioning extending damper. Therefore, the third representative embodiment will be described primarily with regard to the different constructions.

As shown in FIG. 6, the joint member 20 is a damper. The damper is equipped with a cylindrical cylinder 21 and a piston rod 22. One end side of the piston rod 22 is inserted into the cylinder 21. A liquid such as oil or a gas such as air is sealed in the cylinder 21. The piston rod 22 has a tip end portion 22a attached to the tip end of a horizontal shaft portion 23b of a pivot shaft 23. The piston rod 22 and the cylinder 21 are extended along the direction of the horizontal shaft portion 23b. A tip end portion 21a of the cylinder 21 is attached to the visor body 4.

The piston rod 22 is rotatably joined to the cylinder 21, and therefore able to rotate about a central axis relative to the cylinder 21. The sun visor for a vehicle 1 is generally constructed as previously described. The joint member 20 (or the damper) is extended in a cushioning manner when the visor body 4 receives an impact F1 in an axial direction of the horizontal shaft portion 23b. As a result, the joint member 20 prevents the visor body 4 from slipping-off of the pivot shaft 23 in the axial direction via the cushioning action.

When the visor body 4 is rotated about the horizontal shaft portion 23b of the pivot shaft 23, the cylinder 21 and the piston rod 22 of the joint member 20 rotate about the axis relative to each other. As a result, the torsion build-up of the joint member 20 can be eliminated so as to facilitate the rotation of the visor body 4 about the axis of the horizontal shaft portion 23b relative to the pivot shaft 23.

### Fourth Representative Embodiment

The fourth representative embodiment is described with reference to FIG. 7. The fourth representative embodiment is constructed substantially like the first representative embodiment. However, a joint member 30 according to the fourth representative embodiment differs from the joint member 7 of the first representative embodiment in that the joint member 30 is a cushioning extending damper. Therefore, the fourth representative embodiment will be described primarily with regard to the different constructions.

As shown in FIG. 7, the joint member 30 is a damper. The damper is equipped with a cylindrical cylinder 31 and a piston rod 32. The piston rod 32 is inserted on one end side into the cylinder 31. A liquid such as oil or a gas such as air is sealed in the cylinder 31. An intermediate member 34 is rotatably attached to the tip end of a horizontal shaft portion 33b of a pivot shaft 33 so as to rotate about the axis of the horizontal shaft portion 33b. The intermediate member 34 extends toward the joint member 30. A tip end portion 32a of the piston rod 32 is attached to a tip end portion of the intermediate member 34. As a result, the joint member 30 is attached to the pivot shaft 33 via the intermediate member 34. The piston rod 32 and the cylinder 31 extend substantially in parallel to the horizontal shaft portion 33b. A tip end portion 31a of the cylinder 31 is attached to the visor body 4.

The sun visor for a vehicle 1 is generally constructed as described previously. Therefore, the joint member 30 (or the damper) contracts in a cushioning manner when the visor body 4 receives an impact F1 in the axial direction of the horizontal shaft portion 33b. As a result, the joint member 30 prevents the visor body 4 from slipping-off of the pivot shaft 33 in the axial direction via a cushioning action.

When the visor body 4 is turned around the horizontal shaft portion 33b of the pivot shaft 33, the joint member 30 rotates together with the intermediate member 34 about the horizontal shaft portion 33b of the pivot shaft 33. As a result of the rotatably attachment of the intermediate member 34, the torsion build-up of the joint member 30 can be eliminated in order to facilitate the rotation of the visor body 4 about the axis of the horizontal shaft portion 33b relative to the pivot shaft 33.

### Other Possible Embodiments

The present invention should not be limited to the first through fourth representative embodiments, but may be modified into the following modes, for example.

(1) In the modes of the first representative embodiment and the second representative embodiment, the spring (e.g., the coil spring or the compression spring) is utilized as a joint member. However, in another mode rubber, such as a rubber string, may be utilized as the joint member.

(2) In the modes of the third representative embodiment and the fourth representative embodiment, the piston rod is attached to the pivot shaft, and the cylinder is attached to the visor body. However, in another mode the piston rod may be attached to the visor body, and the cylinder may be attached to the pivot shaft.

(3) In the mode of the third representative embodiment, the cylinder and the piston rod are joined so as to rotate about the axis of the horizontal shaft portion relative to each other. However, in another mode the piston rod may be attached to the pivot shaft so as to rotate about the axis. Alternatively, the cylinder may be attached to the visor body so as to rotate about the axis. According to these modes, when the visor body is rotated about the horizontal shaft portion of the pivot shaft, the cylinder or the piston rod rotates about the axis relative to the pivot shaft or the visor body. As a result, possible torsion build-up of the cylinder can be eliminated in order to facilitate the rotation of the visor body about the axis relative to the pivot shaft.

This invention claims:

1. A sun visor for a vehicle comprising:
a visor body for shielding against light that might otherwise come into a cabin of the vehicle; and
a pivot shaft inserted into the visor body and rotatably supporting the visor body about a central axis of the pivot shaft;
wherein the visor body includes a joint member therein for joining the visor body to the pivot shaft; and
wherein the joint member resiliently reacts to partially adsorb a force applied to the visor body in a removal direction of the visor body from the pivot shaft along the central axis of the pivot shaft.

2. The sun visor for a vehicle as in claim 1, wherein the joint member is made of an elastic member comprising:
one end portion attached to the pivot shaft;
an other end portion attached to the visor body;
wherein the elastic member extends along an axis coincident to the central axis of the pivot shaft;
wherein the one end portion or the other end portion is rotatably attached to the pivot shaft or the visor body so as to rotate about the axis relative to the pivot shaft or the visor body when the visor body is rotated about the axis.

3. The sun visor for a vehicle as in claim 2, wherein the elastic member is a coil spring that surrounds an outer circumference of the pivot shaft;
wherein the one end portion of the coil spring is attached to the pivot shaft via a sliding abutment with a flange located at a tip end of the pivot shaft;
wherein the other end portion of the coil spring is attached to the visor body via a sliding abutment with a contacting portion formed in the visor body; and
wherein the coil spring is contracted when the visor body is subjected to the force.

4. The sun visor as in claim 2, wherein the elastic member is a coil spring that extends beyond a tip end of the pivot shaft;
wherein the one end portion of the coil spring is rotatably attached to the tip end of the pivot shaft;
wherein the other end portion of the coil spring is rotatably attached to the visor body;
wherein coil spring is expanded when the visor body is subjected to the force.

5. The sun visor for a vehicle as in claim 1, wherein the joint member is made of a damper comprising:
a cylinder;
a piston rod wherein one end side of the piston rod is slidably inserted into the cylinder;
wherein one of the cylinder or the piston rod is attached to the pivot shaft and extends along an axis coincident to the central axis of the pivot shaft;
wherein an other of the cylinder or the piston rod is attached at an extending tip end of the other of the cylinder or the piston rod to the visor body;
wherein the cylinder rotates relative to the piston rod when the visor body is rotated about the axis; and
wherein the damper is expanded when the visor body is subjected to the force.

6. The sun visor for a vehicle as in claim 5, wherein a dampening media of the cylinder is air.

7. The sun visor for a vehicle as in claim 1, wherein the joint member is made of a damper comprising:
a cylinder;
a piston rod wherein one end side of the piston rod is slidably inserted into the cylinder;
wherein one of the cylinder or the piston rod is attached to the pivot shaft and extends along an axis coincident to the central axis of the pivot shaft;
wherein an other of the cylinder or the piston rod is attached at an extending tip end of the other of the cylinder or the piston rod to the visor body; and
wherein the attachment of at least one of the cylinder or the piston rod to the pivot shaft or the visor body is a rotatable attachment allowing the at least one of the cylinder or the piston rod to rotate relative to the pivot shaft or the visor body when the visor body is rotated about the axis;
wherein the damper is expanded when the visor body is subjected to the force.

8. The sun visor for a vehicle as in claim 7, wherein a dampening media of the cylinder is air.

9. The sun visor for a vehicle as in claim 1, wherein the joint member is made of a damper comprising:
a cylinder;
a piston rod wherein one end side of the piston rod is slidably inserted into the cylinder;
an intermediate member;
wherein one end of the intermediate member is rotatably attached to the pivot shaft;
wherein an other end of the intermediate member is attached to one end of the piston rod;
wherein a tip end of the cylinder is attached to the visor body;
wherein the cylinder and the piston rod extend along an axis parallel to the central axis of the pivot shaft;
wherein the damper is contracted when the visor body is subjected to the force.

10. The sun visor for a vehicle as in claim 9, wherein a dampening media of the cylinder is air.

11. The sun visor for a vehicle as in claim 9, wherein the intermediate member is integrally formed with the piston rod.

12. A sun visor for a vehicle comprising:
a visor body for shielding against light that might otherwise enter into a cabin of the vehicle; and
a pivot shaft inserted into the visor body and rotatably supporting the visor body on an axis; and
wherein the visor body includes an elastic member therein for joining the visor body to the pivot shaft; and
wherein the elastic member is expanded or contracted when the visor body is subjected to a force in a removal direction of the visor body from the pivot shaft along the axis;
wherein the expansion or contraction adsorbs at least a portion of the force.

13. A sun visor for a vehicle as in claim 12, wherein the elastic member is a coil spring comprising:
one end portion interfaces with the pivot shaft;
an other end portion interfaces with the visor body;
wherein a center line of the coil spring is coincident to the axis;
wherein the one end portion or the other end portion is rotatably interfaced with the pivot shaft or the visor body so as to relatively rotate about the axis when the visor body is rotated about the axis of the pivot shaft.

14. The sun visor for a vehicle as in claim 13, wherein the coil spring is coiled about the outer circumference of the pivot shaft; and
wherein the interface between the one end portion of the coil spring and the pivot shaft is a sliding abutment of the one end portion against a flange formed at a tip end of the pivot shaft;
wherein the interface between the other end portion of the coil spring and the visor body is a sliding abutment of the other end portion and a contacting portion formed in the visor body;
wherein the coil spring is elastically contracted when the visor body is subjected to the impact in the removal direction.

15. The sun visor for a vehicle as in claim 13, wherein the coil spring extends beyond a tip end of the pivot shaft;
wherein the interface between the one end portion of the coil spring and the pivot shaft is an attachment of the one end portion and the tip end of the pivot shaft;
wherein the interface between the other end portion of the coil spring and the visor body is an attachment of the other end portion and the visor body;
wherein at least one of the attachments is a rotatable attachment allowing the coil spring to rotate relative to the pivot shaft or the visor body when the visor body is rotated about the axis;
wherein the coil spring is expanded when the visor body is subjected to the force.

16. A sun visor for a vehicle for shielding a cabin of a vehicle against a section of light that would otherwise enter, wherein the sun visor comprises:
a visor body fixedly secured to a bearing located therein; and
a pivot shaft comprising:
a first pivot shaft section with a first axis rotatably attached to a ceiling of the vehicle; and
a second pivot shaft section with a second axis substantially perpendicular to the first axis and rotatably attached to the bearing;
wherein the visor body is rotatable about the second axis via the bearing;
wherein the visor body further includes a joint member therein for joining the visor body to the pivot shaft; and
wherein the joint member resiliently reacts to partially adsorb a component force of a resultant force applied to the visor body;
wherein the component force is a portion of the resultant force applied to the visor body that is parallel to the second axis of the pivot shaft in a removal direction of the visor body from the pivot shaft.

17. The sun visor for a vehicle as in claim 16, wherein the joint member is a coil spring coiled around the second pivot shaft section, wherein the coil spring comprises:
one end portion of the coil spring attached to the second pivot shaft section via an abutment with a flange located at a tip end of the second pivot shaft section;
an other end portion of the coil spring attached to the visor body via an abutment with a contacting portion formed in the visor body;
wherein at least one of the abutments is a sliding abutment so that the coil spring can rotate relative to the second pivot shaft section or the visor body when the visor body is rotated about the second axis;
wherein the coil spring is contracted when the visor body is subjected to the component force.

18. The sun visor for a vehicle as in claim 16, wherein the joint member is a coil spring coiled around an axis coincident to the second axis, wherein the coil spring comprises:
one end portion of the coil spring attached to the second pivot shaft section;
an other end portion of the coil spring attached to the visor body;
wherein at least one of the attachments is a rotating attachment so that the coil spring can rotate relative to the second pivot shaft section or the visor body when the visor body is rotated about the second axis;
wherein the coil spring is expanded when the visor body is subjected to the component force.

19. The sun visor for a vehicle as in claim 16, wherein the joint member is a damper comprising:
a cylinder;
a piston rod wherein one end side of the piston rod is slidably inserted into the cylinder;
wherein one of the cylinder or the piston rod is attached to the second pivot shaft section and extends along an axis coincident to the second axis;
wherein an other of the cylinder or the piston rod is attached to the visor body at an extending tip end of the other of the cylinder or the piston rod;
wherein the cylinder rotates relative to the piston rod when the visor body is rotated about the axis; and
wherein the damper is expanded when the visor body is subjected to the component force.

20. The sun visor for a vehicle as in claim 19, wherein a dampening media of the cylinder is air.
